(19) United States
(12) Patent Application Publication
(10) Pub. No.: US 2025/0306983 A1
(43) Pub. Date: Oct. 2, 2025

(54) METHOD FOR MANAGING REFERENCE COUNT OF OBJECT AND NON-TRANSITORY MACHINE-READABLE MEDIUM FOR STORING PROGRAM CODE THAT PROVIDES THE METHOD WHEN EXECUTED

(71) Applicant: MEDIATEK INC., Hsin-chu (TW)

(72) Inventors: Sheng-Jie Shu, Hsinchu City (TW); Cheng-Hsin Shen, Hsinchu City (TW); Chia-Chen Yen, Hsinchu City (TW); Qi-Wei Yang, Hsinchu City (TW)

(73) Assignee: MEDIATEK INC., Hsin-chu (TW)

(21) Appl. No.: 18/623,060

(22) Filed: Apr. 1, 2024

(51) Int. Cl. G06F 9/48; G06F 9/32

(52) U.S. Cl. CPC G06F 9/485; G06F 9/321

(57) ABSTRACT

A method for managing an object may comprise: creating the object by calling a first function through an application programming interface (API); and separately managing a user reference count and a system reference count to manage a life cycle of the object. In addition, a non-transitory machine-readable medium stores a program code, wherein when loaded and executed by a heterogeneous computing system, the program code instructs the heterogeneous computing system to execute the method.

### BACKGROUND

The present disclosure is related to management of an object, and more particularly, to reference count management of an object.

Open computing language (OpenCL) is a framework for developing programs on a heterogeneous computing system including a central processing unit (CPU), a graphics processing unit (GPU), and other processors (e.g., a digital signal processor (DSP)). Specifically, OpenCL is an open standard for parallel programs in the heterogeneous computing system, and may define different objects, such as a platform, a device, a context, a program, a kernel, etc. In the related art, there may be a dependency relationship between different objects, a life cycle of an object may be determined by a reference count, and the reference count may record the number of times the object is referenced. A life cycle of an object starts from the creation of the object and ends when the object is destroyed.

For a conventional method, when an object is created in OpenCL, the reference count of the object is initially set to 1. When the object is retained (or released) through an application programming interface (API) of OpenCL, 1 is added to (or subtracted from) the reference count. Under a condition that the object is dependent on another object, 1 is added to the reference count when the object is retained through an object dependency between the object and another object, and if another object is destroyed, 1 is subtracted from the reference count of the object. When the reference count is decreased to 0, resources occupied by the object may be recycled by OpenCL framework (i.e., the object may be destroyed). Since the reference count may change according to user operations (e.g., function calling through the API) and system operations (e.g., object dependencies), some problems may occur. For example, after the reference count of an object becomes 0 and the object is destroyed, the object may be illegally released by the user or system, which will cause an error, such as a fatal error (e.g., a segmentation fault (invalid memory access) or an undefined behavior). For another example, if the user or the system fails to release an object sufficient, it will also cause an error (e.g., memory leak). The conventional method has difficulty to recognize whether an error is caused by the user operations or the system operations.

### SUMMARY

It is therefore one of the objectives of the present disclosure to provide a method for managing an object and a non-transitory machine-readable medium for storing a program code that provides the method when executed, to address the above-mentioned issues.

According to an embodiment of the present disclosure, a method for managing an object is provided. The method may comprise: creating the object by calling a first function through an API; and separately managing a user reference count and a system reference count of the object to manage a life cycle of the object.

According to an embodiment of the present disclosure, a non-transitory machine-readable medium for storing a program code is provided. When loaded and executed by a heterogeneous computing system, the program code instructs the heterogeneous computing system to execute following steps: create an object by calling a first function through an API; and separately managing a user reference count and a system reference count of the object to manage a life cycle of the object.

One of the benefits of the present disclosure is that, by separately managing a user reference count and a system reference count of an object, when an error occurs in a heterogeneous computing system, it can be quickly determined whether the error is caused by user operations (e.g., calling the functions) or by system operations (e.g., object dependencies). As a result, the object management efficiency and the overall performance of the heterogeneous computing system can be improved.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a heterogeneous computing system according to an embodiment of the present disclosure.

FIG. 2 is a diagram illustrating a method for separately managing a user reference count and a system reference count of an object according to an embodiment of the present disclosure.

### DETAILED DESCRIPTION

Certain terms are used throughout the following description and claims which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

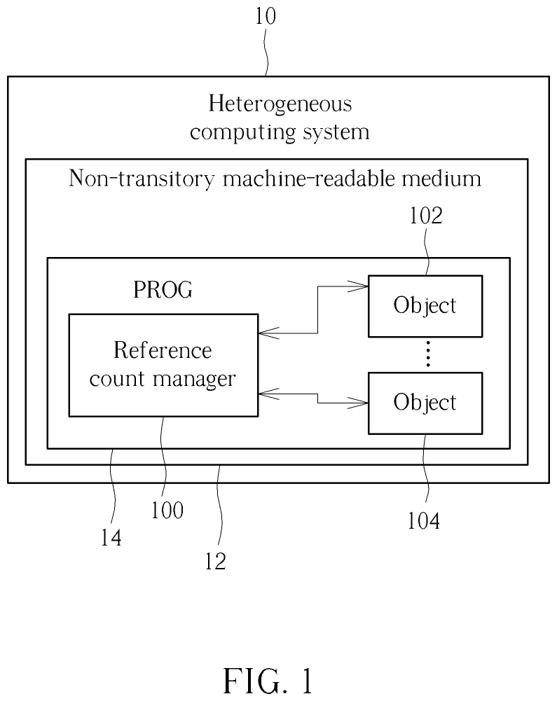

FIG. 1 is a diagram illustrating a heterogeneous computing system 10 according to an embodiment of the present disclosure. The heterogeneous computing system 10 has an Open computing language (OpenCL) framework, and may be implemented in a portable device, such as a mobile phone, a tablet, a wearable device, etc. However, this is not meant to be a limitation of the present disclosure. That is, any electronic device using the proposed method falls within the scope of the present disclosure. As shown in FIG. 1, the heterogeneous computing system 10 may have a non-transitory machine-readable medium 12 such as a memory device. The non-transitory machine-readable medium 12 may store a program code 14. In this embodiment, the heterogeneous computing system 10 may have a reference count manager 100 and a plurality of objects 102 and 104, and the reference count manager 100 and the objects 102 and 104 may be a part of the program code 14 (labeled as “PROG” in FIG. 1). Examples of each of the objects 102 and 104 may include, but are not limited to: a platform, a device, a context, a program, and a kernel. For clarity and simplicity, only two objects 102 and 104 are illustrated in FIG. 1. In practice, the heterogeneous computing system 10 may have more than two objects, depending upon actual design considerations. Each of the objects 102 and 104 may have two fields for recording the user reference count URC and the system reference count SRC, respectively, but the present invention is not limited thereto. In some embodiments, the user reference counts URC and the system reference counts SRC of the objects 102 and 104 may be recorded in the reference count manager 100. In addition, the user reference count URC and the system reference count SRC may be two independent counts (or fields), or may be two subparts (e.g., sub-blocks/fields) of a total reference count (i.e., the total reference count includes the user reference count URC and the system reference count SRC). By way of example, but not limitation, the reference count manager 100 may be a part of an operating system (OS) supporting a heterogeneous computing environment. Hence, the reference count manager 100 may be a software module running on the heterogeneous computing system 10, wherein the software module may include an application programming interface (API). It should be noted that, in some embodiments, the heterogeneous computing system 10 may have two reference count managers that correspond to the objects 102 and 104, respectively, and each of the two reference count managers is arranged to manage the user reference count URC and the system reference count SRC of the corresponding object. In some embodiments, the two reference count managers parts of the objects 102 and 104, respectively. These alternative designs all fall within the scope of the present disclosure.

When the program code 14 is loaded and executed by the heterogeneous computing system 10, the reference count manager 100 may perform the proposed method. Specifically, the reference count manager 100 may be arranged to perform the proposed method which is used to manage (e.g., increase or decrease) a user reference count URC and a system reference count SRC for each of the objects 102 and 104 to manage life cycles of the objects. Specifically, the reference count manager 100 may manage the user reference count URC according to a plurality of functions that are called by a user through the API, and manage the system reference count SRC according to a plurality of dependent relationships (also called dependencies) between objects, wherein the plurality of functions may include a function CREATE for creating an object in the heterogeneous computing system 10, a function RETAIN for retaining an object in the heterogeneous computing system 10, and a function RELEASE for releasing an object from the heterogeneous computing system 10, but the present disclosure is not limited thereto. A life cycle of an object starts from the creation of the object and ends when the object is destroyed.

For example, under a condition that the objects 102 and 104 are defined as a program and a kernel, respectively, the program code 14 may include the following pseudo code:
cl_program program=clCreateProgramWithSource ( . . . );
. . .
cl_kernel kernel=clCreateKernel (program, . . . );
. . .
cl_int release_kernel_status=clReleaseKernel(kernel);
. . .
cl_int release_program_status=clReleaseProgram(program);
   wherein “cl_program program=clCreateProgramWithSource ( . . . )” represents that the object 102 is created by calling the function CREATE through the API, “cl_kernel kernel=clCreateKernel(program, . . . )” represents that the object 104 is created by calling the function CREATE through the API, and there is a dependency between the objects 102 and 104, “cl_int release_kernel_status=clReleaseKernel(kernel)” represents that the object 104 is released by calling the function RELEASE through the API, “cl_int release_program_status=clReleaseProgram(program)” represents that the object 102 is released by calling the function RELEASE through the API, and in response to the above operations, the reference count manager 100 may manage the user reference count URC and the system reference count SRC for each of the objects 102 and 104. The pseudo code here is just an example, and is not meant to be as a limitation of the present disclosure. In some embodiments, the objects 102 and 104 may be independent of each other.

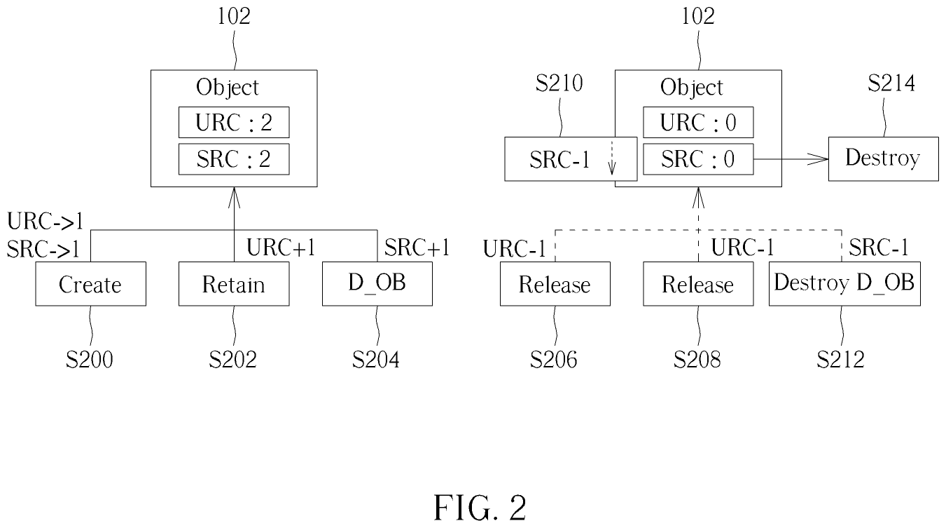

In detail, please refer to FIG. 2. FIG. 2 is a diagram illustrating a method for separately managing the user reference count URC and the system reference count SRC of an object (e.g., the object 102) to manage the life cycle of the object according to an embodiment of the present disclosure. It is assumed that the object 102 is dependent upon an object D_OB. Provided that the result is substantially the same, the steps are not required to be executed in the exact order shown in FIG. 2. For example, the method shown in FIG. 2 may be employed by the reference count manager 100.

In Step S200, the user may call the function CREATE through the API to create the object 102. After creating the object 102, a life cycle of the object 102 starts. In response to the object 102 being created, the user reference count URC and the system reference count SRC of the object 102 may be initially set as a first predetermined value (e.g., URC=SRC=1; for brevity, labeled as “URC->1” and “SRC->1” in FIG. 2). The value “1” is just an example, and is not meant to be as a limitation of the present disclosure. In some embodiments, the first predetermined value could be any predetermined number.

In Step S202, the user may call the function RETAIN through the API to retain the object 102 in the heterogeneous computing system 10. In response to the object 102 being retained by calling the function RETAIN through the API, an adjustment value (e.g., 1) may be added to the user reference count URC (e.g., URC=1+1=2; for brevity, labeled as “URC+1” in FIG. 2).

In Step S204, the object 102 may be retained according to a dependency between the object D_OB and the object 102, and therefore the adjustment value (e.g., 1) may be added to the system reference count SRC (e.g., SRC=1+1=2; for brevity, labeled as “SRC+1” in FIG. 2). For example, when the object D_OB is created, and there is a dependency between the object D_OB and the object 102, the object 102 may be retained. After performing Steps S200, S202, and S204, the user reference count URC and the system reference count SRC of the object 102 may be 2.

In Step S206, the user may call the function RELEASE through the API to release the object 102 from the heterogeneous computing system 10. For example, Step S206 may be executed because of the calling of the function CREATE. That is, a calling of function CREATE is usually followed by a calling of a function of RELEASE. In response to the object 102 being released by calling the function RELEASE, the adjustment value (e.g., 1) may be subtracted from the user reference count URC (e.g., URC=2−1=1; for brevity, labeled as “URC-1” in FIG. 2).

In Step S208, the user may call the function RELEASE again through the API to release the object 102 from the heterogeneous computing system 10. For example, Step S208 may be executed because of the calling of the function RETAIN. That is, a calling of function RETAIN is usually followed by a calling of a function of RELEASE. In response to the object 102 being released by calling the function RELEASE, the adjustment value (e.g., 1) may be subtracted from the user reference count URC (e.g., URC=1−1=0; for brevity, labeled as “URC-1” in FIG. 2).

In Step S210, in response to the user reference count URC being decreased to a second predetermined value (e.g., 0), the adjustment value (e.g., 1) may be subtracted from the system reference count SRC (e.g., SRC=2−1=1; for brevity, labeled as “SRC-1” in FIG. 2). The value “0” is just an example, and is not meant to be as a limitation of the present disclosure. In some embodiments, the second predetermined value could be any predetermined number.

It should be noted that under a condition that the user reference count URC is decreased to the second predetermined value (e.g., 0), if the user tries to additionally call the function REALEASE to release the object 102 from the heterogeneous computing system 10, the release operation will not be performed and the heterogeneous computing system 10 may notify the user that the release operation is illegal.

In Step S212, in response to the object D_OB being destroyed, the adjustment value (e.g., 1) may be subtracted from the system reference count SRC. In this example, 1 may be subtracted from the system reference count SRC (i.e., SRC=1−1=0; for brevity, labeled as “SRC-1” in FIG. 2). In other embodiments, if the system reference count SRC is greater than 1 before Step S212, the system reference count SRC won't become 0 at step S212, only the adjustment value (e.g., 1) is subtracted from the system reference count SRC.

In Step S214, in response to the system reference count SRC being decreased to the second predetermined value (e.g., 0), the object 102 may be destroyed. Besides, like the object 102, the object D_OB will be destroyed when a reference count of the object D_OB becomes 0. In the present disclosure, the object 102 and D_OB is destroyed only when the system reference count SRC of the object 102 and D_OB becomes the second predetermined value (e.g., 0), respectively. When the object 102 is destroyed, a life cycle of the object 102 ends.

In summary, by separately managing a user reference count and a system reference count of an object, when an error occurs in a heterogeneous computing system, it can be quickly determined whether the error is caused by user operations (e.g., calling the functions) or by system operations (e.g., object dependencies). For example, when a memory leak was caused, the error can be recognize with the help of the user reference count value and the system reference count value. Besides, in this disclosure, when the user reference count of an object is decreased to the second predetermined value (e.g., 0), if the user tries to additionally call the function REALEASE to release the object, the release operation will not be performed, such that the illegal release caused by the user operations can be avoided. As a result, the object management efficiency and the overall performance of the heterogeneous computing system can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing an object, comprising:
creating the object by calling a first function through an application programming interface (API); and
separately managing a user reference count and a system reference count of the object to manage a life cycle of the object.

2. The method of claim 1, wherein when creating the object by calling the first function through the application programming interface, initially setting the user reference count and the system reference count as a predetermined value.

3. The method of claim 1, wherein the step of separately managing the user reference count and the system reference count comprises:
in response to the object being retained by calling a second function through the API, increasing the user reference count.

4. The method of claim 1, wherein the step of separately managing the user reference count and the system reference count comprises:
in response to the object being retained according to a dependency between the object and another object, increasing the system reference count.

5. The method of claim 1, wherein the step of separately managing the user reference count and the system reference count comprises:
in response to the object being released by calling a second function through the API, decreasing the user reference count.

6. The method of claim 5, further comprising:
in response to the user reference count being decreased to a predetermined value, subtracting an adjustment value from the system reference count.

7. The method of claim 1, wherein the object is dependent on another object, and the step of separately managing the user reference count and the system reference count comprises:
in response to another object being destroyed, decreasing the system reference count.

8. The method of claim 1, wherein the step of separately managing the user reference count and the system reference count of the object comprises:
in response to the system reference count being decreased to a predetermined value, destroying the object.

9. The method of claim 1, wherein the user reference count and the system reference count are two independent counts.

10. The method of claim 1, wherein the user reference count and the system reference count are two sub-parts of a total reference count.

11. A non-transitory machine-readable medium for storing a program code, wherein when loaded and executed by a heterogeneous computing system, the program code instructs the heterogeneous computing system to execute following steps:
create an object by calling a first function through an application programming interface (API); and
separately managing a user reference count and a system reference count of the object to manage a life cycle of the object.

12. The non-transitory machine-readable medium of claim 11, wherein when creating the object by calling the first function through the application programming interface, initially setting the user reference count and the system reference count as a predetermined value.

13. The non-transitory machine-readable medium of claim 11, wherein the step of separately managing the user reference count and the system reference count comprises:
in response to the object being retained by calling a second function through the API, increasing the user reference count.

14. The non-transitory machine-readable medium of claim 11, wherein the step of separately managing the user reference count and the system reference count comprises:
in response to the object being retained according to a dependency between the object and another object, increasing the system reference count.

15. The non-transitory machine-readable medium of claim 11, wherein the step of separately managing the user reference count and the system reference count comprises:
in response to the object being released by calling a second function through the API, decreasing the user reference count.

16. The non-transitory machine-readable medium of claim 15, further comprising:
in response to the user reference count being decreased to a predetermined value, subtracting an adjustment value from the system reference count.

17. The non-transitory machine-readable medium of claim 11, wherein the object is dependent on another object, and the step of separately managing the user reference count and the system reference count comprises:
in response to another object being destroyed, decreasing the system reference count.

18. The non-transitory machine-readable medium of claim 10, wherein the step of separately managing the user reference count and the system reference count of the object comprises:
in response to the system reference count being decreased to a predetermined value, destroying the object.

19. The non-transitory machine-readable medium of claim 10, wherein the user reference count and the system reference count are two independent counts.

20. The non-transitory machine-readable medium of claim 10, wherein the user reference count and the system reference count are two sub-parts of a total reference count.
